(19) United States
(12) Patent Application Publication
(10) Pub. No.: US 2025/0174815 A1
(43) Pub. Date: May 29, 2025

(54) BATTERY PACK

(71) Applicant: HONDA MOTOR CO., LTD., Tokyo (JP)

(72) Inventors: Daigo KOMATSU, Tokyo (JP); Keiji TAKEUCHI, Tokyo (JP)

(73) Assignee: HONDA MOTOR CO., LTD., Tokyo (JP)

(21) Appl. No.: 18/950,229

(22) Filed: Nov. 18, 2024

(30) Foreign Application Priority Data
Nov. 24, 2023 (JP) 2023-199082

(51) Int. Cl. H01M 50/358; H01M 50/209; H01M 50/264; H01M 50/325

(52) U.S. Cl. CPC H01M 50/358; H01M 50/209; H01M 50/264; H01M 50/325

(57) ABSTRACT

A battery pack has a plurality of laminated battery cells each including a safety valve, an end plate which is provided at an end in a lamination direction of the battery cells, an exhaust duct which connects the safety valves of the battery cells and extends in the lamination direction, a case which accommodates the battery cells, the end plate and the exhaust duct, and a pressure relief valve which is attached to a surface of the case facing the end plate and is configured to exhaust gas discharged from the safety valves out of the case. A space and a plurality of flow paths are provided between the exhaust duct and the pressure relief valve. The space is formed around the end plate and communicates with the exhaust duct. The flow paths are configured to allow the space to communicate with the pressure relief valve.

### CROSS-REFERENCE TO RELATED APPLICATIONS

This application is based on and claims priority under 35 USC 119 from Japanese Patent Application No. 2023-199082 filed on Nov. 24, 2023, the entire content of which is incorporated herein by reference.

### TECHNICAL FIELD

The present disclosure relates to a battery pack obtained by arranging a plurality of laminated battery cells in a case.

### BACKGROUND ART

In recent years, researches and developments have been conducted on a secondary battery which contributes to improvement in energy efficiency in order to allow more people to have access to affordable, reliable, sustainable and advanced energy.

As a drive source of a vehicle is electrified, a battery that supplies power to a motor or the like is mounted on the vehicle. The battery is configured by laminating a plurality of battery cells, for example. Each battery cell is provided with a safety valve for discharging high-temperature and high-pressure gas generated inside the battery cell out of the battery cell.

For example, JP2012-079510A discloses a battery module in which cells each provided with a safety valve are aligned in a case, an exhaust duct is provided by a hood covering the aligned safety valves, an end plate is overlapped on each of the outermost ones among the aligned cells, and two end plates sandwich and fix the plurality of cells. One end plate is provided with a conduction port communicating with the exhaust duct and an exhaust port communicating with the conduction port.

If thermal runaway occurs in the battery module described in JP2012-079510A when the battery module is accommodated in a case to form a battery pack, gas is exhausted from the exhaust port of the end plate, and the inside of the case is filled with the gas. In order to reduce an influence on the outside due to the pressure rise in the case, there is a demand for a configuration capable of limiting the pressure rise in the case while appropriately exhausting the gas in the case out of the case.

### SUMMARY OF INVENTION

The present disclosure provides a battery pack capable of appropriately exhausting gas generated during thermal runaway of battery cells out of the case, while limiting a pressure rise in the case due to the gas. This further contributes to improvement in energy efficiency.

An aspect of the present disclosure relates to a battery pack including:

a plurality of laminated battery cells each including a safety valve;

an end plate provided at an end in a lamination direction of the battery cells;

an exhaust duct connecting the safety valves of the battery cells and extending in the lamination direction;

a case accommodating the battery cells, the end plate, and the exhaust duct; and

a pressure relief valve attached to a surface of the case facing the end plate and configured to exhaust gas discharged from the safety valves out of the case,

in which a space and a plurality of flow paths are provided between the exhaust duct and the pressure relief valve, the space being formed around the end plate and communicating with the exhaust duct, and the flow paths being configured to allow the space to communicate with the pressure relief valve.

According to the aspect of the present disclosure, it is possible to appropriately exhaust gas generated during thermal runaway of battery cells out of the case, while limiting a pressure rise in the case due to the gas.

### BRIEF DESCRIPTION OF DRAWINGS

Exemplary embodiment(s) of the present invention will be described in detail based on the following figures, wherein:

FIG. 1 is an external perspective view of a battery pack 10 according to a first embodiment;

FIG. 2 is an exploded perspective view of the battery pack 10 according to the first embodiment;

FIG. 3 is an exploded perspective view of a cell laminate 30;

FIG. 4 illustrates a step of accommodating a plurality of battery cells 40 in a case body 21 in a pressurized manner;

FIG. 5 illustrates a flow of gas (a broken line arrow) guided to a pressure relief valve 13;

FIG. 6 is a partial cross-sectional perspective view of the vicinity of the pressure relief valve 13;

FIG. 7 is an exploded perspective view of a battery pack 10 according to a second embodiment;

FIG. 8 is a cross-sectional view of a pressurization plate 28 in a state where the plurality of battery cells 40 and the end plate 31 are pressed; and

FIG. 9 illustrates a flow of gas (broken line arrows) flowing through a buffer space 47 formed around the end plate 31 and a plurality of exhaust flow paths 48 provided in the pressurization plate 28.

### DESCRIPTION OF EMBODIMENTS

Hereinafter, each embodiment of a battery pack of the present disclosure will be described with reference to the accompanying drawings. In the following description, for convenience, a coordinate system including a front-rear direction, a left-right direction, and an upper-lower direction orthogonal to each other is used. In the drawings, the front side is denoted by Fr, the rear side is denoted by Rr, the left side is denoted by L, the right side is denoted by R, the upper side is denoted by U, and the lower side is denoted by D. However, these directions are not related to a direction when the battery pack is mounted on a device. For example, when the battery pack is mounted on a vehicle, an upper-lower direction of the battery pack may be oriented in a traveling direction of the vehicle or in a vehicle width direction when the battery pack is mounted on the vehicle.

### First Embodiment

### [Battery Pack]

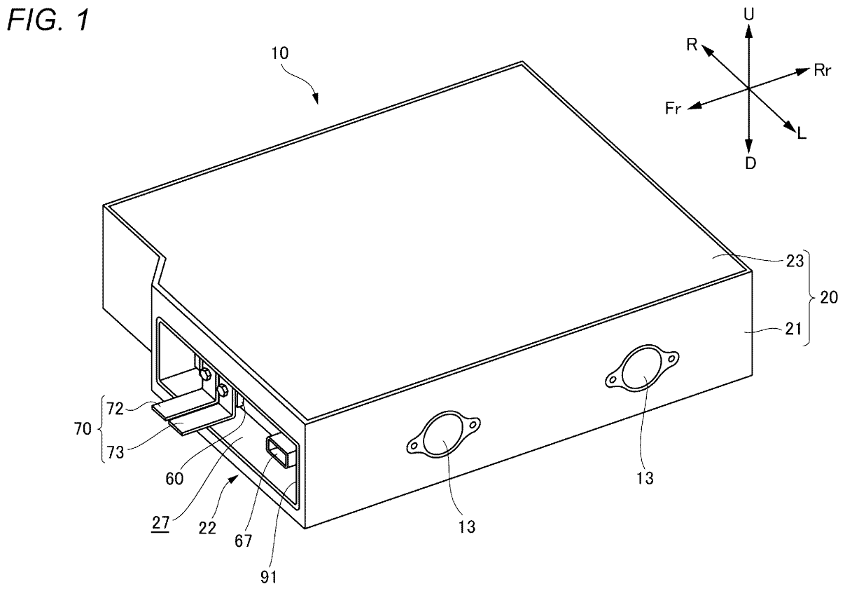

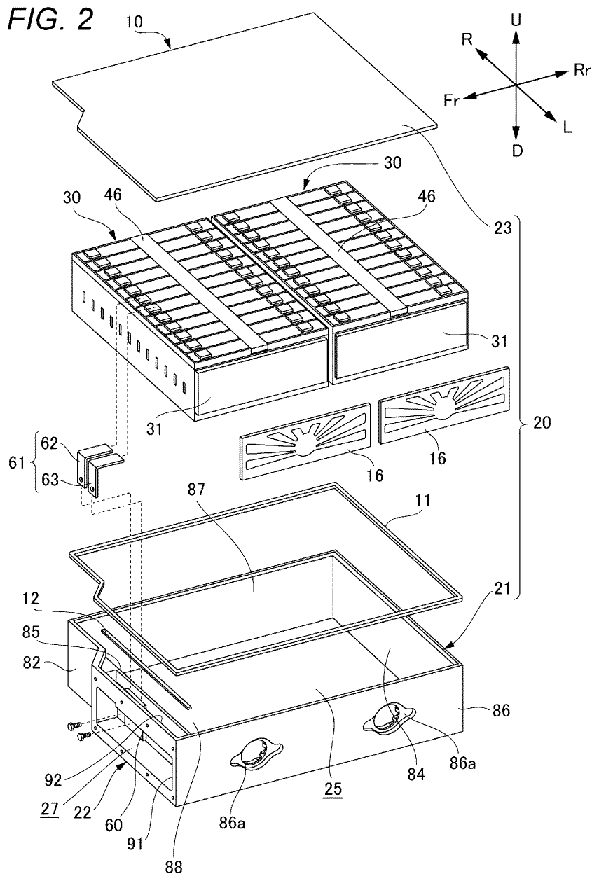

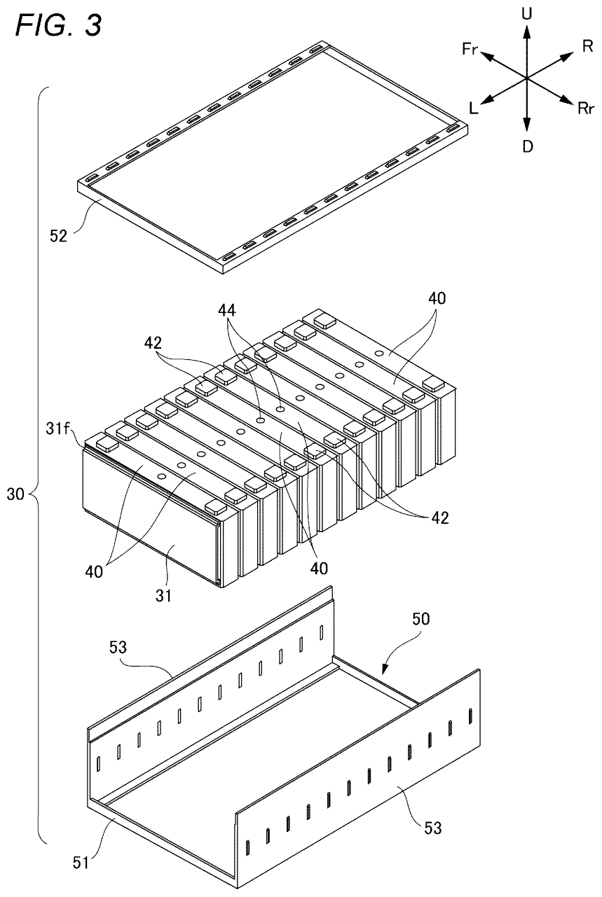

First, a battery pack of a first embodiment will be described. In the battery pack 10, as illustrated in FIGS. 1 and 2, two cell laminates 30 are aligned in the front-rear direction inside a box-shaped case 20. As illustrated in FIG. 3, each cell laminate 30 includes a plurality of square battery cells 40 laminated in the left-right direction, and an end plate 31 disposed on one side in the left-right direction (the left side in the present embodiment), which are temporarily fixed at a predetermined pressure by using a binder 50. A separator (not illustrated) may be disposed between adjacent battery cells 40. The binder 50 includes a rectangular lower restraint portion 51 surrounding the bottom surface of the cell laminate 30, a rectangular upper restraint portion 52 surrounding the upper surface of the cell laminate 30, and a pair of side restraint portions 53 sandwiching the cell laminate 30 in the front-rear direction. The lower restraint portion 51 and the pair of side restraint portions 53 are formed integrally. The other side in the left-right direction (the right side in the present embodiment) of the cell laminate 30 may be provided with another end plate, a separator, or the like, so that the battery cells 40 are not in direct contact with the case 20 on the other side. The cell laminate 30 may not be configured such that the plurality of battery cells 40 are restrained by the binder 50. That is, the plurality of battery cells 40 may be directly laminated inside the case 20.

The end plate 31 includes a flange 3 If at the lower end and the upper end. The flange 31f is restrained by the lower restraint portion 51 and the upper restraint portion 52, whereby the end plate 31 is fixed to the plurality of battery cells 40. Since the flange 31f is provided, the contact surface between the end plate 31 and the battery cells 40 is widened, thereby preventing the reaction force from the end plate 31 from being locally applied to the battery cells 40.

The battery cells 40 are each, for example, a secondary battery such as a lithium ion battery. The upper surface of each battery cell 40 is provided with a pair of terminals 42 provided at both ends in the front-rear direction, which is a direction orthogonal to the lamination direction of the battery cells 40, and a safety valve 44 provided at the central portion in the front-rear direction and arranged between the pair of terminals 42. The pair of terminals 42 include a positive terminal and a negative terminal. For example, the positive terminal is connected to the negative terminal of an adjacent battery cell 40 via a bus bar (not illustrated), and the negative terminal is connected to the positive terminal of an adjacent battery cell 40 via a bus bar (not illustrated), whereby the plurality of battery cells 40 are electrically connected in series. For example, in order to shorten the length of the bus bar, the plurality of battery cells 40 may be laminated such that the orientations thereof in the front-rear direction are reversed alternately.

The safety valve 44 is a rupture valve, and prevents rupture of the outer can when the internal pressure of the battery cell 40 abnormally rises. If the internal pressure of the battery cell 40 abnormally rises, the safety valve 44 ruptures and the gas in the battery cell 40 is discharged to the outside. By providing the safety valve 44 in the central portion of the battery cell 40 in the front-rear direction, the plurality of battery cells 40 can be aggregated at the same position in the front-rear direction even if laminated such that the orientations thereof in the front-rear direction are reversed alternately.

The battery cells 40 are provided with an exhaust duct 46 that connects the safety valves 44 of the plurality of battery cells 40 and that allows the gas discharged from the safety valves 44 to flow. For example, the exhaust duct 46 is configured with a hood that covers the safety valves 44. The exhaust duct 46 extends in the direction in which the safety valves 44 are aligned, that is, in the lamination direction of the battery cells 40, and guides the gas toward a pressure relief valve 13 to be described later.

Returning to FIG. 2, the case 20 includes a case body 21 whose upper side is open, and a case cover 23 that covers the opening of the case body 21. The case body 21 includes a front wall 82 and a rear wall 84 that extend in the left-right direction, a left wall 86 that connects the left ends of the front wall 82 and the rear wall 84, a right wall 87 that connects the right ends of the front wall 82 and the rear wall 84, and a bottom wall 88. A space surrounded by the front wall 82, the rear wall 84, the left wall 86, and the right wall 87 constitutes a cell accommodation space 25 for accommodating the cell laminates 30.

The left wall 86 is provided with two openings 86a that allow the cell accommodation space 25 to communicate with the outside. One opening 86a faces the cell laminate 30 located forward, and the other opening 86a faces the cell laminate 30 located rearward. Each opening 86a is provided at a position facing the central portion of the battery cells 40 as viewed from the lamination direction of the battery cells 40.

As illustrated in FIG. 1, each opening 86a has a pressure relief valve 13 communicating with the cell accommodation space 25 attached thereto. When the internal pressure of the cell accommodation space 25 abnormally rises due to the gas discharged from the safety valve 44, the pressure relief valve 13 is opened to exhaust the gas out of the case 20 and release the pressure in the case 20. The opening 86a and the pressure relief valve 13 have substantially the same size. The opening 86a is closed when attached with the pressure relief valve 13.

The opening 86a and the pressure relief valve 13 are provided to face the central portion of the battery cells 40 as viewed from the lamination direction. As a result, the rigidity of the case 20 can be prevented from lowering as compared with a case where, for example, the opening 86a and the pressure relief valve 13 are provided at a position shifted from the central portion of the battery cells 40 (for example, a position above the central portion) when viewed from the lamination direction.

A plate-shaped spacer 16 is provided between the left wall 86 and the end plate 31. By providing the spacer 16, the plurality of battery cells 40 and the end plate 31 are sandwiched and held in a pressurized state between the left wall 86 and the right wall 87 in the cell accommodation space 25.

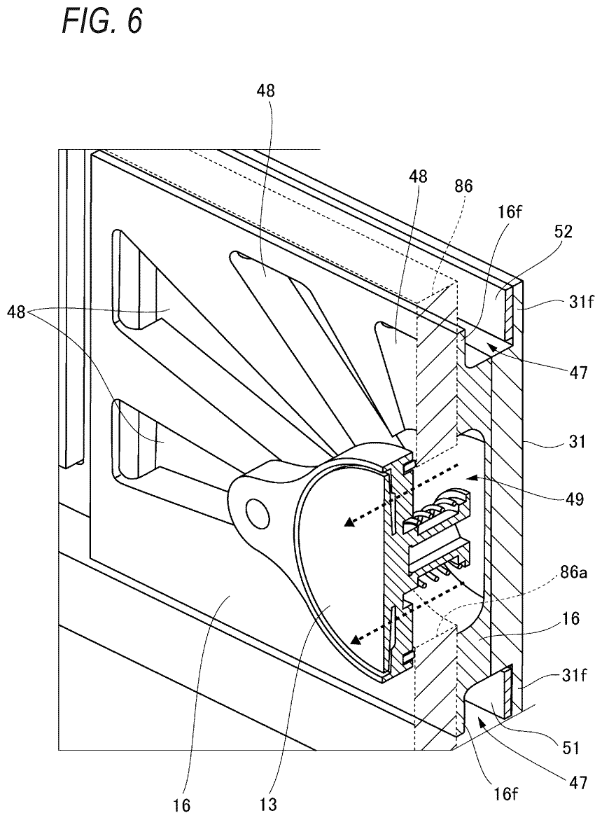

As illustrated in FIG. 6, the spacer 16 includes a flange 16f on a surface facing the left wall 86 and has a wide contact surface with the left wall 86. Since the flange 31f is provided, the contact surface between the spacer 16 and the left wall 86 is widened, thereby preventing the reaction force from the spacer 16 from being locally applied to the left wall 86.

Returning to FIG. 2, an expanded portion 22 is formed forward of and leftward of the front wall 82 in a manner protruding further forward of the front wall 82. The expanded portion 22 has a space formed inside, and has a first opening 91 provided in the front surface and a second opening 92 provided in the upper surface. The internal space of the expanded portion 22 is provided with a terminal block 60 connected with a lead-out conductive member 70, and forms an output terminal accommodation space 27. Electrically connected in the terminal block 60 are a terminal (output terminal) of an output conductive member 61 extending from the cell accommodation space 25 to the output terminal accommodation space 27, and a terminal of the lead-out conductive member 70 entering the output terminal accommodation space 27 from the first opening 91. The output conductive member 61 includes a positive-side bus bar 62 and a negative-side bus bar 63 respectively extending from the positive-side output terminal and the negative-side output terminal of the two cell laminates 30 electrically connected in series. The lead-out conductive member 70 includes, for example, a positive-side bus bar 72 and a negative-side bus bar 73 respectively connected to external positive terminal and negative terminal.

As described above, the case 20 is provided with the cell accommodation space 25 that accommodates the two cell laminates 30, and the output terminal accommodation space 27 arranged forward of and leftward of the cell accommodation space 25 and connected with the lead-out conductive member 70. The number of the cell laminates 30 accommodated in the cell accommodation space 25 may be one or three or more.

A region of the front wall 82 that separates the cell accommodation space 25 from the output terminal accommodation space 27 (hereinafter, this portion is referred to as a partition wall 85) is lower in height than the other regions. The positive-side bus bar 62 and the negative-side bus bar 63 extend from above the partition wall 85 to the output terminal accommodation space 27, and are fixed to the terminal block 60 provided in the output terminal accommodation space 27.

As illustrated in FIG. 1, the output terminal accommodation space 27 is provided with a signal line connector 67. The signal line connector 67 is connected with a signal line via a through hole that allows the cell accommodation space 25 to communicate with the output terminal accommodation space 27.

As illustrated in FIG. 2, the upper surface of the case 20 is attached with a case cover 23 via a first seal member 11 (for example, a rubber seal), except for the partition wall 85. The case cover 23 is fixed to the upper surface of the case 20 by welding such as friction stir welding, for example. The gap between the partition wall 85 and the case cover 23 is provided with a second seal member 12 (for example, a foamed seal). The cell accommodation space 25 is sealed from the outside by the first seal member 11 and the second seal member 12. By sealing the cell accommodation space 25 from the outside, it is possible to limit intrusion of foreign matters into the cell accommodation space 25, thereby limiting deterioration of the battery cells 40. It is preferable to further provide a seal member such as a foamed seal in the gap between the through hole provided in the partition wall 85 and the signal line.

The battery pack 10 configured as described above does not include an auxiliary device such as an ECU or a junction box that accommodates a comparator, a fuse, and the like. Therefore, if the battery pack 10 is used alone, the battery pack 10 may be connected to a junction box and/or an ECU. If a plurality of battery packs 10 are used, the battery packs 10 may be electrically connected to each other in a connection box, and the connection box may be connected to a junction box and/or an ECU. Further, a junction box and/or an ECU may be incorporated in a connection box, and the plurality of battery packs 10, the junction box and/or the ECU may be connected in the connection box.

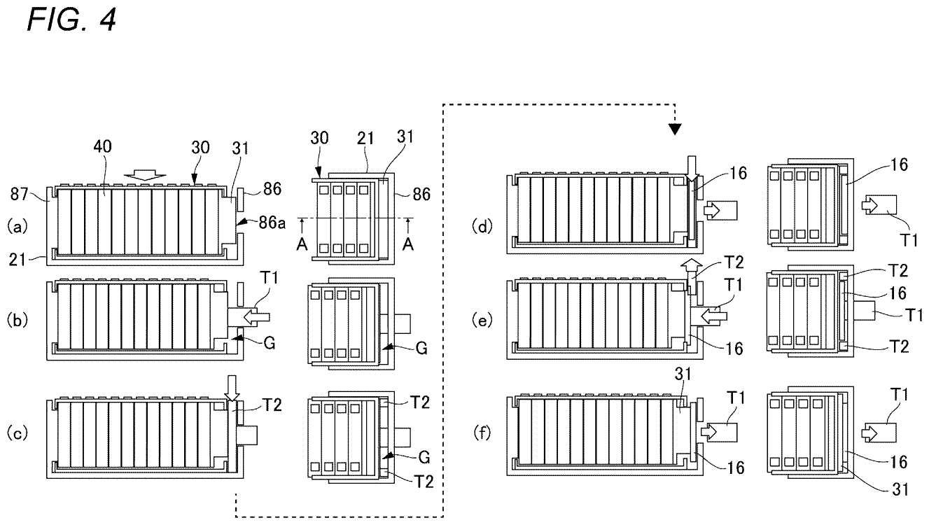

Next, the step of accommodating the plurality of battery cells 40 in the case body 21 in a pressurized manner will be described in detail with reference to FIG. 4. At each phase shown as (a) to (f) in FIG. 4, the right diagram is a top view of the battery pack 10, and the left diagram is a cross-sectional view taken along line A-A.

First, as illustrated in phase (a) in FIG. 4, the plurality of battery cells 40 and the end plate 31 (that is, the cell laminate 30) temporarily fixed by the binder 50 are accommodated in the cell accommodation space 25 of the case body 21 from above. At this time, the end plate 31 faces the left wall 86 of the case body 21, and the right side surface of the plurality of battery cells 40 face the right wall 87 of the case body 21. In this state, the plurality of battery cells 40 and the end plate 31 are held in a pressurized state and arranged with margin in the case body 21.

Next, as illustrated in phase (b) in FIG. 4, a jig T1 is inserted through the opening 86a provided in the left wall 86, and the plurality of battery cells 40 are pressed toward the right wall 87 via the end plate 31 by the jig T1. Accordingly, the right side surface of the plurality of battery cells 40 is in contact with the right wall 87, and the plurality of battery cells 40 and the end plate 31 temporarily fixed by the binder 50 are further pressurized in the lamination direction.

Next, as illustrated in phase (c) in FIG. 4, temporary spacers T2 are disposed between the end plate 31 and the left wall 86 in a state where the end plate 31 is pressed by the jig T1. The temporary spacers T2 are rod-shaped members extending in the upper-lower direction, and are arranged at both ends of the end plate 31. By disposing the temporary spacers T2, the plurality of battery cells 40 and the end plate 31 are held in a pressurized state in the case body 21 even after the jig T1 is detached, and a gap G is formed between the end plate 31 and the left wall 86.

Next, as illustrated in phase (d) in FIG. 4, the spacer 16 is arranged in the gap G after the jig T1 is detached. The thickness of the spacer 16 (here, the length in the lamination direction) is set equal to or less than the thickness of the temporary spacers T2.

Next, as illustrated in phase (e) in FIG. 4, the spacer 16 is pressed by inserting the jig T1 again from the opening 86a, thereby increasing the gap G and allowing the two temporary spacers T2 to be removed.

Finally, as illustrated in phase (f) in FIG. 4, the jig T1 is removed. In this state, the plurality of battery cells 40 and the end plate 31 are densely arranged in the case body 21 in the lamination direction via the spacers 16, and are held in a pressurized state. On the contrary, the case body 21 receives the reaction force of the plurality of pressurized battery cells 40.

After the jig T1 is detached from the opening 86a at phase (f) in FIG. 4, the pressure relief valve 13 is attached to the opening 86a as illustrated in FIG. 1. In this way, the opening 86a is not only the insertion port of the jig T1 used when pressing the plurality of battery cells 40 and the end plate 31 against the case body 21, but also the attachment port of the pressure relief valve 13.

According to the battery pack 10 thus formed, the plurality of battery cells 40 can be held in the case 20 without being modularized, thereby improving the energy density and the space efficiency.

### [Gas Exhaust Structure]

Some abnormality occurring in the battery cells 40, for example, an internal short circuit, may generate thermal runaway, i.e. abnormal heat generation, in the battery cells 40, and generate high-temperature and high-pressure gas inside the battery cells 40. When the pressure of the gas generated inside the battery cells 40 rises to a predetermined value or more, the safety valve 44 ruptures, and the gas is discharged out of the battery cells 40, that is, into the case 20.

The inside of the case 20 is sealed to prevent liquid or foreign matters from entering, but the battery pack 10 is provided with the pressure relief valve 13 to exhaust the gas out of the case 20 during thermal runaway. However, since the battery cells 40 are arranged closely while being pressurized by the case 20 via the end plate 31 and the spacer 16, the gap between the battery cells 40 and the case 20 is small, and the inside of the case 20 tends to have a high pressure when discharging the gas from the safety valve 44. Since a pressure rise in the case 20 may lead to the rupture of the case 20, it is preferable to appropriately provide a space for releasing the pressure inside the case 20 in addition to providing the pressure relief valve 13.

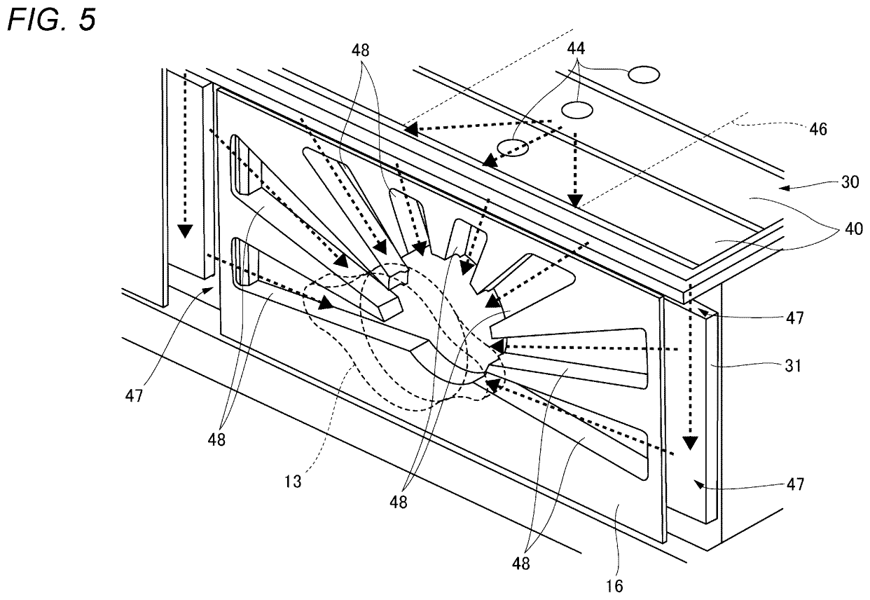

As illustrated in FIGS. 5 and 6, provided between the exhaust duct 46 and the pressure relief valve 13 are the buffer space 47 communicating with the exhaust duct 46 and functioning as a space for releasing pressure, and the plurality of exhaust flow paths 48 communicating with the buffer space 47 and the pressure relief valve 13.

The buffer space 47 is provided around the end plate 31. Specifically, the buffer space 47 is provided in a rectangular shape along the entire periphery of the end plate 31. The buffer space 47 communicates with the exhaust duct 46 at the upper portion of the end plate 31. The gas discharged from the safety valve 44 flows into the buffer space 47 through the exhaust duct 46. The gas flowing into the buffer space 47 flows along the upper portion, the front portion, the rear portion, and the lower portion of the edge of the end plate 31, and flows into the plurality of exhaust flow paths 48. The buffer space 47 may not be provided along the entire circumference of the end plate 31, and may have a configuration in which, for example, the buffer space 47 communicates with the upper portion, the front portion, and the rear portion of the edge of the end plate 31 and is provided in a substantially inverted U shape.

As described above, even in a battery pack 10 in which a plurality of battery cells 40 are arranged in the case 20 densely while being pressurized, the buffer space 47 as a space for releasing the pressure can be provided appropriately, and the pressure rise in the case 20 can be limited.

The buffer space 47 will be described in more detail. A portion of the buffer space 47 along the upper portion and the lower portion of the end plate 31 is provided between the flange 31f of the end plate 31 and the flange 16f of the spacer 16. Accordingly, the buffer space 47 can be appropriately partitioned by using the flange 31f of the end plate 31 and the flange 16f of the spacer 16.

A portion of the buffer space 47 along the front portion and the rear portion of the end plate 31 corresponds to the portion for arranging the temporary spacers T2, and is provided between the end plate 31 and the left wall 86 of the case body 21. Accordingly, the portion for arranging the temporary spacers T2 can also be used as a space for releasing the pressure.

The plurality of exhaust flow paths 48 are provided in the spacer 16 to guide the gas flowing into the buffer space 47 to the pressure relief valve 13 and exhaust the gas from the pressure relief valve 13 out of the case 20. The plurality of exhaust flow paths 48 are formed by, for example, notching the surface of the spacer 16.

The plurality of exhaust flow paths 48 extend radially from the pressure relief valve 13 toward the buffer space 47. More specifically, as illustrated in FIG. 6, the spacer 16 is provided with a merging portion 49 where the plurality of exhaust flow paths 48 are merged at a position facing the central portion of the battery cells 40 as viewed from the lamination direction. The merging portion 49 is formed by recessing the central portion of the spacer 16. The plurality of exhaust flow paths 48 extend radially from the merging portion 49 toward the buffer space 47. The gas discharged from the safety valve 44 due to thermal runaway is exhausted from the pressure relief valve 13 out of the case 20 via the exhaust duct 46, the buffer space 47, the plurality of exhaust flow paths 48, and the merging portion 49.

Since the plurality of exhaust flow paths 48 extend radially, the gas can be guided from the buffer space 47 provided around the end plate 31 to the pressure relief valve 13 in a balanced manner. In addition, since the plurality of exhaust flow paths 48 extend radially, the stress applied to the spacer 16 is dispersed. Therefore, even in the configuration having the plurality of exhaust flow paths 48, the spacer 16 can ensure sufficient rigidity without impairing the function of receiving the reaction force from the battery cells 40.

Each exhaust flow path 48 has a large flow path width on the upstream side (closer to the buffer space 47) in the gas flow direction and a small flow path width on the downstream side (closer to the pressure relief valve 13). Similar to the buffer space 47, the plurality of exhaust flow paths 48 function as a space for releasing the pressure inside the case 20. Therefore, the space for releasing the pressure can be increased by increasing the flow path width on the upstream side. On the other hand, since the spacer 16 needs to sufficiently receive the reaction force from the battery cells 40, a decrease in rigidity of the spacer 16 due to the provision of the plurality of exhaust flow paths 48 can be limited by decreasing the flow path width on the downstream side.

### Second Embodiment

Next, a battery pack of a second embodiment will be described. Here, the same reference numerals as in the above-described first embodiment are used for the same configurations, and the description of the first embodiment may be incorporated.

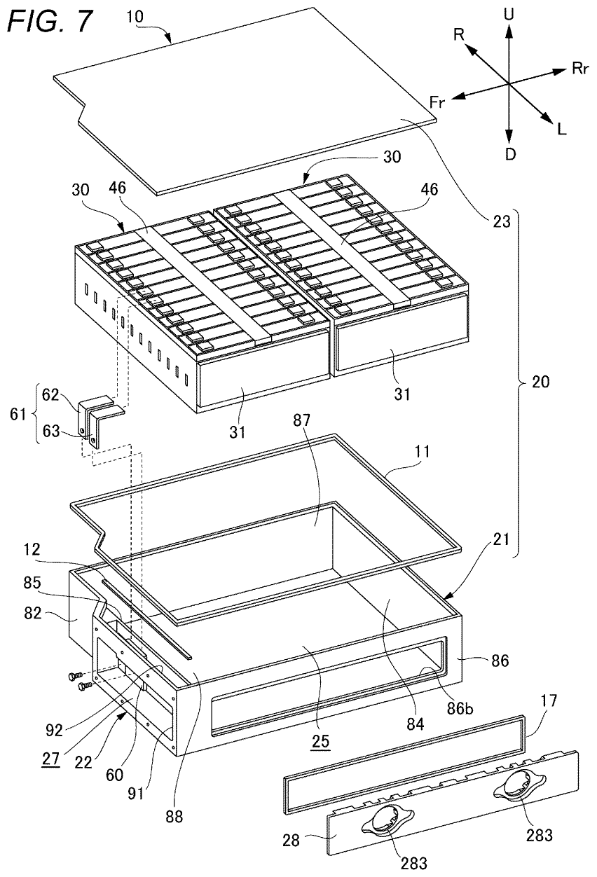

In the battery pack of the first embodiment, the plurality of battery cells 40 are pressurized by the spacer 16, but the battery pack 10 of the second embodiment includes a pressurization plate 28 provided in the case body 21 instead of the spacer 16 as illustrated in FIG. 7, and the plurality of battery cells 40 are pressurized by using the pressurization plate 28.

The left wall 86 of the case 20 is provided with an opening 86b that allows the cell accommodation space 25 to communicate with the outside. The pressurization plate 28 is attached to the left wall 86 to cover the opening 86b via a seal member 17 (e.g., a rubber seal), and constitutes a portion of the left wall 86 of the case body 21. The pressurization plate 28 may be fixed to the left wall 86 by welding such as friction stir welding, or may be fixed by bolts. In the battery pack 10 of the second embodiment as well, similar as in the case of the first embodiment, the plurality of battery cells 40 can be held in the case 20 without being modularized, thereby improving the energy density and the space efficiency.

The opening 86b has a substantially rectangular shape and is larger than the opening 86a of the first embodiment. On the other hand, the opening 86b is smaller than the flange 31f of the end plate 31. This can prevent the rigidity of the case 20 from lowering due to a large opening 86b.

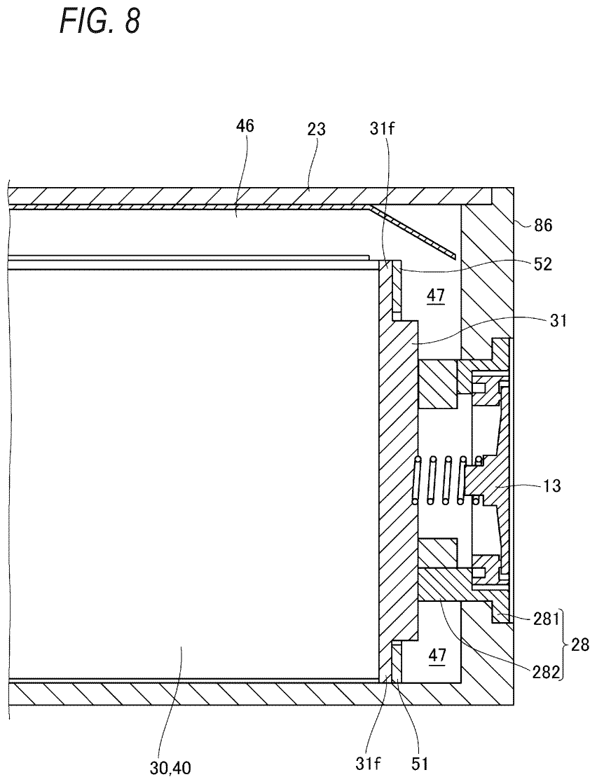

As illustrated in FIG. 8, the pressurization plate 28 includes a flange 281 that faces the edge of the opening 86b, convex portions 282 that are inserted into the case 20 from the opening 86b and press the end plates 31, and two openings 283 each attached with the pressure relief valve 13. The outer position of the case 20 in the opening 86b is formed with a step. The pressurization plate 28 is fixed to the left wall 86 such that the flange 281 is fitted into the step.

By fixing the pressurization plate 28 to the left wall 86, the convex portion 282 of the pressurization plate 28 comes into contact with the end plate 31 of each cell laminate 30. When the convex portion 282 of the pressurization plate 28 presses the end plate 31, the plurality of battery cells 40 temporarily fixed to the binder 50 are further pressurized in the lamination direction and held in the case 20.

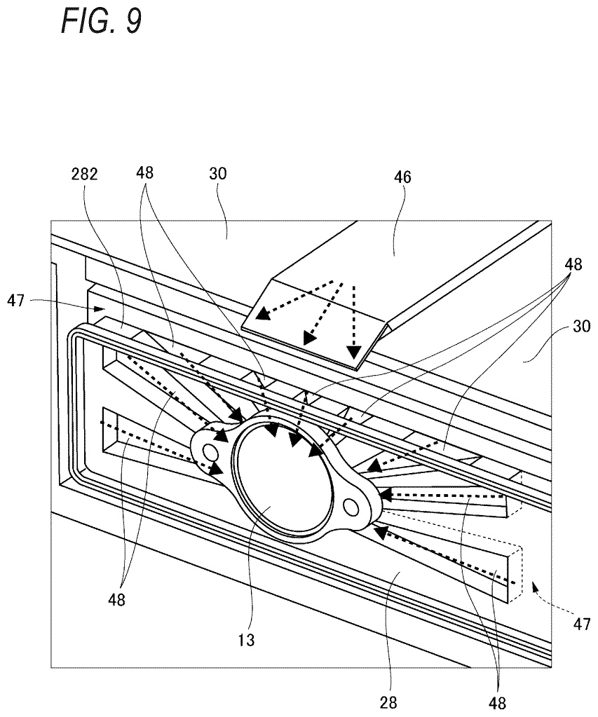

As illustrated in FIGS. 8 and 9, in the second embodiment, the buffer space 47 is provided around the end plate 31 as in the first embodiment, while the pressure relief valve 13 and the plurality of exhaust flow paths 48 are provided in the pressurization plate 28.

The buffer space 47 is provided around the flange 3 1f of the end plate 31 and the convex portion 282 of the pressurization plate 28, and is partitioned by the end plate 31, the pressurization plate 28, and the case 20. In the present embodiment, the buffer space 47 is also provided along the entire circumference of the flange 31f.

Two pressure relief valves 13 are attached to close the two openings 283 provided in the pressurization plate 28. The pressure relief valve 13 and the opening 283 are provided to face the central portion of the battery cells 40 as viewed from the lamination direction. As a result, the rigidity of the pressurization plate 28, that is, the rigidity of the case 20 can be prevented from lowering as compared with a case where, for example, the pressure relief valve 13 and the opening 283 are arranged at a position shifted from the central portion of the battery cells 40 when viewed from the lamination direction.

The plurality of exhaust flow paths 48 are provided in the convex portion 282 of the pressurization plate 28 to guide the gas flowing into the buffer space 47 to the pressure relief valve 13 and exhaust the gas from the pressure relief valve 13 out of the case 20. The plurality of exhaust flow paths 48 extend radially from the pressure relief valve 13 toward the buffer space 47. The plurality of exhaust flow paths 48 provided in the pressurization plate 28 have the same configuration as the plurality of exhaust flow paths 48 provided in the spacer 16.

As described above, even in a battery pack 10 in which a plurality of battery cells 40 are arranged in the case 20 densely while being pressurized, the buffer space 47 as a space for releasing the pressure can be provided appropriately, and the pressure rise in the case 20 can be limited. Further, the gas can be appropriately guided to the pressure relief valve 13 through the plurality of exhaust flow paths 48 provided in the pressurization plate 28 and exhausted out of the case.

Although the embodiments of the present disclosure have been described above with reference to the accompanying drawings, it is needless to say that the present invention is not limited to the embodiments. It is apparent that those skilled in the art can conceive of various modifications and changes within the scope described in the claims, and it is understood that such modifications and changes naturally fall within the technical scope of the present invention. In addition, the constituent elements in the above embodiments may be freely combined without departing from the gist of the invention.

For example, in the above-described embodiment, the end plate 31 is disposed on only one side in the lamination direction of the plurality of battery cells 40 (the left side in the embodiment), but may be disposed on both sides in the lamination direction of the plurality of battery cells 40.

In the present specification, at least the following matters are described. In the parentheses, the corresponding constituent elements and the like in the above embodiment are shown as an example, but the present invention is not limited thereto.

(1) A battery pack (battery pack 10) including:
a plurality of laminated battery cells (battery cells 40) each including a safety valve (safety valve 44);
an end plate (end plate 31) provided at an end in a lamination direction of the battery cells;
an exhaust duct (exhaust duct 46) connecting the safety valves of the battery cells and extending in the lamination direction;
a case (case 20) accommodating the battery cells, the end plate, and the exhaust duct; and
a pressure relief valve (pressure relief valve 13) attached to a surface of the case facing the end plate and configured to exhaust gas discharged from the safety valves out of the case,
in which a space (buffer space 47) and a plurality of flow paths (exhaust flow paths 48) are provided between the exhaust duct and the pressure relief valve, the space being formed around the end plate and communicating with the exhaust duct, and the flow paths being configured to allow the space to communicate with the pressure relief valve.

According to (1), even if gas is discharged from the safety valves of the battery cells due to thermal runaway, the pressure can be released to the space formed around the end plate and thus the pressure rise in the case can be limited. In addition, the gas discharged from the battery cells can be appropriately guided to the pressure relief valve and exhausted out of the case by the plurality of flow paths that allow the space to communicate with the pressure relief valve.

(2) The battery pack according to (1),
in which the plurality of flow paths extend radially from the pressure relief valve toward the space.

According to (2), the gas discharged from the safety valve can be guided from the space around the end plate to the pressure relief valve in a balanced manner.

(3) The battery pack according to (1) or (2),
in which the end plate is provided on a one-end side of the battery cells in the lamination direction,
the battery cells are in contact with the case on an other-end side in the lamination direction, and
the battery cells are accommodated in the case while being pressed from the one-end side toward the other-end side.

According to (3), even in a battery pack in which a plurality of battery cells are pressed and densely accommodated in a case, the pressure can be released to the space formed around the end plate and the pressure rise in the case can be limited.

(4) The battery pack according to (3), further including:
a spacer (spacer 16) provided between the end plate and the case in the lamination direction and configured to press the battery cells via the end plate,
in which the plurality of flow paths are provided in the spacer.

According to (4), the spacer that presses the battery cell can have a function of guiding the gas to the pressure relief valve.

(5) The battery pack according to (4),
in which the end plate includes a flange (flange 31f) on a surface facing the battery cells,
the spacer includes a flange (flange 16f) on a surface facing the case, and
at least a part of the space is provided between the flange of the end plate and the flange of the spacer.

According to (5), the flange of the end plate and the flange of the spacer can prevent local stress from acting on the battery cells and the case when the battery cells are pressed. Further, the space for releasing the pressure can be appropriately partitioned by using the flanges.

(6) The battery pack according to (3),
in which the case includes:
   an opening (opening 86b) provided in a surface facing the end plate; and
   a pressurization plate (pressurization plate 28) inserted into the opening and configured to press the battery cells via the end plate, and
the pressure relief valve and the plurality of flow paths are provided in the pressurization plate.

According to (6), the pressurization plate that presses the battery cells can have a function of guiding the gas to the pressure relief valve.

(7) The battery pack according to (6),
in which the pressurization plate includes:
   a flange (flange 281) facing an edge of the opening; and
   a convex portion (convex portion 282) protruding from the opening to an inside of the case and configured to press the battery cell via the end plate, and
the plurality of flow paths are provided in the convex portion.

According to (7), the convex portion of the pressurization plate that presses the battery cells can have a function of guiding the gas to the pressure relief valve.

(8) The battery pack according to (7),
in which the end plate includes a flange (flange 31f) on a surface facing the battery cells, and
the opening of the case is smaller than the flange of the end plate.

According to (8), the flange of the end plate can prevent local stress from acting on the battery cells when the battery cells are pressed. Furthermore, by making the opening of the case smaller than the flange of the end plate, the rigidity of the case can be prevented from deteriorating due to a large opening.

(9) The battery pack according to (8),
in which the space is provided around the flange of the end plate and the convex portion of the pressurization plate.

According to (9), the space for releasing the pressure can be appropriately partitioned by the flange of the end plate and the convex portion of the pressurization plate.

(10) The battery pack according to any one of (1) to (9),
in which the pressure relief valve is provided in the case to face a central portion of the battery cells as viewed from the lamination direction.

According to (10), it is possible to limit a decrease in rigidity of the case.

What is claimed is:

1. A battery pack comprising:
a plurality of laminated battery cells each including a safety valve;
an end plate provided at an end in a lamination direction of the battery cells;
an exhaust duct connecting the safety valves of the battery cells and extending in the lamination direction;
a case accommodating the battery cells, the end plate, and the exhaust duct; and
a pressure relief valve attached to a surface of the case facing the end plate and configured to exhaust gas discharged from the safety valves out of the case,
wherein a space and a plurality of flow paths are provided between the exhaust duct and the pressure relief valve, the space being formed around the end plate and communicating with the exhaust duct, and the flow paths being configured to allow the space to communicate with the pressure relief valve.

2. The battery pack according to claim 1,
wherein the plurality of flow paths extend radially from the pressure relief valve toward the space.

3. The battery pack according to claim 1,
wherein the end plate is provided on a one-end side of the battery cells in the lamination direction,
the battery cells are in contact with the case on an other-end side in the lamination direction, and
the battery cells are accommodated in the case while being pressed from the one-end side toward the other-end side.

4. The battery pack according to claim 3, further comprising:
a spacer provided between the end plate and the case in the lamination direction and configured to press the battery cells via the end plate,
wherein the plurality of flow paths are provided in the spacer.

5. The battery pack according to claim 4,
wherein the end plate includes a flange on a surface facing the battery cells,
the spacer includes a flange on a surface facing the case, and
at least a part of the space is provided between the flange of the end plate and the flange of the spacer.

6. The battery pack according to claim 3,
wherein the case includes:
an opening provided in a surface facing the end plate; and
a pressurization plate inserted into the opening and configured to press the battery cells via the end plate, and
the pressure relief valve and the plurality of flow paths are provided in the pressurization plate.

7. The battery pack according to claim 6,
wherein the pressurization plate includes:
a flange facing an edge of the opening; and
a convex portion protruding from the opening to an inside of the case and configured to press the battery cell via the end plate, and
the plurality of flow paths are provided in the convex portion.

8. The battery pack according to claim 7,
wherein the end plate includes a flange on a surface facing the battery cells, and
the opening of the case is smaller than the flange of the end plate.

9. The battery pack according to claim 8,
wherein the space is provided around the flange of the end plate and the convex portion of the pressurization plate.

10. The battery pack according to claim 1,
wherein the pressure relief valve is provided in the case to face a central portion of the battery cells as viewed from the lamination direction.
